(19) United States
(12) Patent Application Publication
(10) Pub. No.: US 2022/0373017 A1
(43) Pub. Date: Nov. 24, 2022

(54) Fall-Proof Component for Screw, Fall-Proof Screw Assembly, Fall-Proof Screw-Nut Assembly and Corresponding Part, Combination Structure and Assembly

(71) Applicant: Fresenius Medical Care Deutschland GmbH, Bad Homburg (DE)

(72) Inventors: Winfried Brehm, Hofheim (DE); Gesa Gercke, Schweinfurt (DE); Zhongxiang Liang, Shanghai (CN); Yijia Zhang, Liaoning (CN)

(21) Appl. No.: 17/773,993

(22) PCT Filed: Nov. 7, 2019
(86) PCT No.: PCT/CN2019/116293

§ 371 Date: May 3, 2022

(51) Int. Cl. F16B 41/00; F16B 21/08; F16B 43/02

(52) U.S. Cl. CPC F16B 41/002; F16B 21/08; F16B 43/02

(57) ABSTRACT

Herein disclosed is a fall-proof component for a screw, comprising: a first structure configured to act on a portion of the screw to stop the screw; and a second structure configured to be fitted and latched onto a part which is to be fixed by the screw; wherein the first structure and the second structure cooperate with each other to prevent the screw from falling and the fall-proof component is configured to be adapted to be disposed adjacent to a head of the screw in a fitted status. Also disclosed are a corresponding fall-proof screw assembly, a corresponding fall-proof screw-nut assembly, a corresponding part suitable for the fall-proof screw assembly, a corresponding combination structure and a corresponding assembly. According to the disclosure, the fall-proof component has a simple structure and a low cost and can be reusable.

### CROSS-REFERENCE TO RELATED APPLICATIONS

The present application is the national stage entry of International Patent Application No. PCT/CN2019/116293, filed on Nov. 7, 2019, the contents of which are hereby incorporated by reference.

### TECHNICAL FIELD

The disclosure relates to a fall-proof component for a screw, a fall-proof screw assembly, a fall-proof screw-nut assembly, a part suitable for the fall-proof screw assembly, a combination structure and a corresponding assembly.

### BACKGROUND ART

As is well-known, a screw is widely used in various products to fix a part to another part. However, there may be a falling problem for the screw, which may cause many problems, such as undesired separation of the fixed parts, waste of material and time, especially in massive production industry.

Particularly for medical devices, falling of the screw will lead to more serious problems, such as failure of the medical devices, entering of medical fluid or disinfectant into interior of the medical devices. Moreover, in the medical device industry, plastic is applied as cover material for its good chemical resistance and cleanability. Screw fall-proof solution also has significant meaning in assembling and maintenance of device.

Currently several mechanisms have been used to solve this problem but remain some disadvantages including non-standard screw, easy damage of inserted nuts of plastic parts, much space requirement and many additional parts.

For example, some kinds of snap-in fasteners are adopted in sheet metal that can achieve a fall-proof function. However, the snap-in fasteners need to use a customized screw that will have a relative high cost. The snap-in fasteners also need to be fixed at both sides and cannot provide enough support for the inserted nut. Some of the snap-in fasteners also require further manufacturing step after the screw is put in, which will lead to an increased cost and make the fastener not reusable.

Another example is some kinds of fall-proof washers in some electronic products. Their main problem is that the washer can only fix screws from a side of the nut. Such a washer occupies some space or structure which could be used for supporting the inserted nut. When the screw is fastened, the inserted nut may be pulled out and thus the corresponding part may be damaged.

### SUMMARY OF THE DISCLOSURE

In view of one or more of the problems existing in the prior art, an object of the disclosure is to provide an improved fall-proof component for a screw, a corresponding fall-proof screw assembly, a corresponding fall-proof screw-nut assembly, a corresponding part suitable for the fall-proof screw assembly, a corresponding combination structure and a corresponding assembly.

For achieving this object, according to a first aspect, provided is a fall-proof component for a screw, comprising: a first structure configured to act on a portion of the screw to stop the screw; and a second structure configured to be fitted and latched onto a part which is to be fixed by the screw; wherein the first structure and the second structure cooperate with each other to prevent the screw from falling and the fall-proof component is configured to be adapted to be disposed adjacent to a head of the screw in a fitted status.

According to an optional embodiment, the first structure and the second structure are integrated as a single fall-proof member; and/or the fall-proof component is configured to be reusable; and/or the fall-proof component is configured to be detachable from the part.

According to an optional embodiment, the fall-proof member is at least partially made of elastic material; and/or the fall-proof member is integrally molded.

According to an optional embodiment, the elastic material is plastic; and/or the fall-proof member is molded by injection molding.

According to an optional embodiment, the fall-proof component is configured as a fall-proof washer.

According to an optional embodiment, the fall-proof washer comprises a through hole acting as the first structure; and/or the second structure is disposed at a peripheral edge of the fall-proof washer.

According to an optional embodiment, the through hole is configured to hold the fall-proof washer on the screw; and/or the second structure comprises a slot and/or a protrusion formed on the peripheral edge of the fall-proof washer.

According to an optional embodiment, the fall-proof washer is held on the screw by self-tapping the screw into the through hole; and/or the slot is configured such that the fall-proof washer is able to be fitted in place by a temporary deformation of the slot and is able to be latched onto the part by the peripheral edge of the fall-proof washer; and/or the protrusion is configured such that the fall-proof washer is able to be fitted in place by a temporary deformation, of exemplarily the protrusion, of the fall-proof washer and is able to be latched onto the part by the protrusion.

According to an optional embodiment, the fall-proof component is configured as a fall-proof cover adapted to be disposed above the head of the screw.

According to an optional embodiment, the fall-proof cover comprises a through hole configured to allow for screwing the screw with a tool; and/or the fall-proof cover is configured to have a recess adapted to be engaged onto the head of the screw.

According to an optional embodiment, the fall-proof cover is configured in a bowl shape; and/or the second structure comprises a slot and/or a protrusion formed on a peripheral edge of the fall-proof cover.

According to an optional embodiment, the slot is configured such that the fall-proof cover is able to be fitted in place by a temporary deformation of the slot and is able to be latched onto the part by the peripheral edge of the fall-proof cover; and/or the protrusion is configured such that the fall-proof cover is able to be fitted in place by a temporary deformation, of exemplarily the protrusion, of the fall-proof cover and is able to be latched onto the part by the protrusion.

According to an optional embodiment, the protrusion is configured as a hook.

According to a second aspect, provided is a fall-proof screw assembly comprising the fall-proof component described above and the screw.

According to a third aspect, provided is a fall-proof screw-nut assembly comprising the fall-proof screw assembly described above and a nut for the screw.

According to a fourth aspect, provided is a part suitable for a fall-proof screw assembly, wherein the part is provided with a receiving seat for receiving the fall-proof screw assembly described above, which receiving seat is provided with a cooperative structure for cooperating with the second structure to prevent the screw from falling.

According to an optional embodiment, the cooperative structure is configured such that the fall-proof component still is able to be latched onto the part even if the screw is unscrewed from the nut.

According to a fifth aspect, provided is a combination structure comprising the part described above as a first part and a second part provided with a nut, wherein the first part and the second part are configured to be fixed with each other at least by engaging of the screw in the fall-proof screw assembly described above with the nut.

According to an optional embodiment, the nut is inserted in the second part during injection molding of the second part; and/or the first part is provided with a support structure configured to support the nut to prevent pulling the nut out of the second part during screwing the screw into the nut; and/or the combination structure is configured as a housing for a touch screen monitor.

According to a sixth aspect, provided is an assembly comprising the combination structure described above and the fall-proof screw assembly described above.

According to the disclosure, the fall-proof component has a simple structure and a low cost and can be reusable.

### BRIEF DESCRIPTION OF THE DRAWINGS

The disclosure and advantages thereof will be further understood by reading the following detailed description of some exemplary embodiments with reference to the drawings in which:

FIG. 1 shows in a sectional view a fall-proof component according to an exemplary embodiment of the present disclosure in a fitted status, for a screw for fixing an upper housing part with a lower housing part, wherein the fall-proof component is configured as a fall-proof washer.

FIG. 2 shows in a perspective view a status in which the fall-proof washer is fitted onto the screw.

FIG. 3 only shows the fall-proof washer in a perspective view.

FIG. 4 shows a fall-proof cover according to an exemplary embodiment of the present disclosure in a similar manner to FIG. 1.

FIG. 5 shows in a sectional view a status in which the fall-proof cover is disposed above a head of the screw.

FIG. 6 shows the fall-proof cover in a similar manner to FIG. 3.

### DETAILED DESCRIPTION OF EXEMPLARY EMBODIMENTS

Some exemplary embodiments of the present disclosure will be described hereinafter in more details with reference to the drawings to better understand the basic concept of the present disclosure.

Herein, proposed firstly is a fall-proof component for a screw, comprising: a first structure configured to act on a portion of the screw to stop the screw; and a second structure configured to be fitted and latched onto a part which is to be fixed by the screw; wherein the first structure and the second structure cooperate with each other to prevent the screw from falling and the fall-proof component is configured to be adapted to be disposed adjacent to a head of the screw in a fitted status.

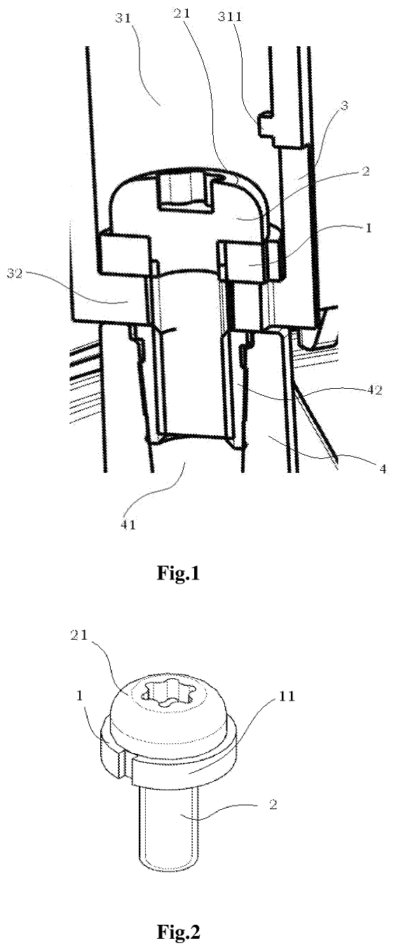

FIG. 1 shows in a sectional view the fall-proof component 1 according to an exemplary embodiment of the present disclosure in a fitted status, for the screw 2 for fixing an upper housing part 3 with a lower housing part 4. In this case, the part which is to be fixed by the screw is the upper housing part 3.

For example, the upper housing part 3 and the lower housing part 4 are able to be fixed with each other to form a housing for a touch display panel, such as a medical monitor for monitoring a medical process, in particular a dialysis treatment process.

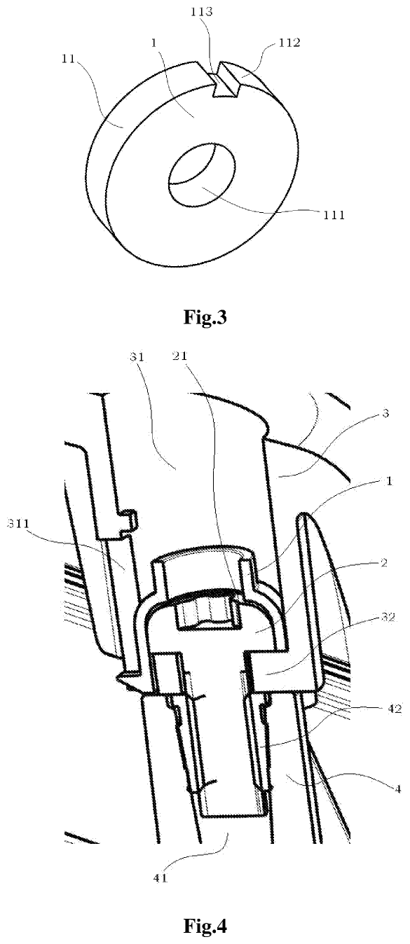

FIG. 2 shows in a perspective view a status in which the fall-proof component 1 is fitted onto the screw 2, and FIG. 3 only shows the fall-proof component 1 in a perspective view.

As shown in FIG. 1 to FIG. 3, the fall-proof component 1 is configured as a fall-proof washer 11, wherein the fall-proof washer 11 comprises a through hole 111 acting as the first structure, and the second structure is disposed at a peripheral edge 112 of the fall-proof washer 11.

According to an exemplary embodiment of the present disclosure, the through hole 111 is configured to hold the fall-proof washer 11 on the screw 2. As an example, the fall-proof washer 11 is held on the screw 2 by self-tapping the screw 2 into the through hole 111. In this case, a diameter of the through hole 111 is smaller a diameter of a corresponding portion of the screw 2. With such a self-tapping, the fall-proof washer 11 is able to be held together even after many times of fastening and loosening.

Of course, the fall-proof washer 11 is able to be held on the screw 2 in any other suitable manners, for example in an interference fit manner or by a radial clamping pressure on the corresponding portion of the screw 2 which is generated by the fall-proof washer 1 in the fitted status.

According to an exemplary embodiment of the present disclosure, as shown in FIG. 2 and FIG. 3, the second structure comprises a slot 113 formed on the peripheral edge 112 of the fall-proof washer 11.

Also, as can be seen from FIG. 1, the upper housing part 3 is provided with a receiving seat 31 for receiving a fall-proof screw assembly comprising the screw 2 and the fall-proof washer 11 as an example of the fall-proof component 1. The receiving seat 31 herein is configured as a hole, in particular a counterbore. Further, as an example, the receiving seat 31 is provided with a cooperative structure 311, for example on an inner wall thereof, for cooperating with the second structure to prevent the screw 2 from falling. As an example, the cooperative structure 311 is configured as a protrusion, as shown in FIG. 1.

According to an exemplary embodiment of the present disclosure, the lower housing part 4 is correspondingly provided with a recess 41 for fixedly receiving a nut 42 to be engaged with the screw 2.

As an example, the upper housing part 3 and/or the lower housing part 4 is made of plastic for example by injection molding. In particular, the nut 42 is inserted in the lower housing part 4 during injection molding of the lower housing part 4. By this manner, the nut 42 is able to be fixed firmly and easily on the lower housing part 4.

During the fitting process, the fall-proof washer 11 is firstly held onto the screw 2 as shown in FIG. 2, the screw 2 together with the fall-proof washer 11 is placed into the receiving seat 31 of the upper housing part 3, the fall-proof washer 11 is moved below the cooperative structure 311, and then the screw 2 is screwed tightly into the nut 42 on the lower housing part 4, thereby fixing the upper housing part 3 and the lower housing part 4 together.

It should be understood by the skilled person in the art that the fall proof washer 11 also is able to be firstly placed into the receiving seat 31 and moved below the cooperative structure 311 and then the screw 2 is inserted through the through hole 111 of the fall-proof washer 11 and finally screwed into the nut 42.

According to an exemplary embodiment of the present disclosure, the slot 113 is configured such that the fall-proof washer 11 is able to be fitted in place by a temporary deformation of the slot 113 and is able to be latched onto the upper housing part 3 by the peripheral edge 112 of the fall-proof washer 11. More specifically, during fitting process of the fall-proof washer 11 in place, the slot 113 of the fall-proof washer 11 is firstly aligned with the protrusion as an example of the cooperative structure 311 and then the fall-proof washer 11 is pressed downward at least by a predetermined pressure so that the slot 113 is expanded for example by elastic deformation so as to allow the slot 113 to pass the protrusion on the receiving seat 31, thereby fitting the fall-proof washer 11 below the cooperative structure 311. After the slot 113 passes the protrusion, the deformation of the slot 113 will disappear at least partially so that the protrusion become larger than the slot 113 again and thus the fall-proof washer 11 is able to be latched onto the upper housing part 3 by the peripheral edge 112 of the fall-proof washer 11. In this case, the fall-proof washer 11 and thus the screw 2 are able to be prevented from falling even when the screw 2 is loosened. In this way, the screw 2 with the fall-proof washer 11 will be kept in the receiving seat 31 during maintenance.

It should be understood by the skilled person in the art that the fall-proof washer 11 also is configured such that the fall-proof washer 11 is able to be fitted and latched onto the upper housing part 3 only by a temporary deformation of the fall-proof washer 11, even without the slot 113.

According to an exemplary embodiment of the present disclosure, the protrusion on the receiving seat 31 is configured such that the fall-proof washer 11 is able to be fitted in place by a temporary deformation of the protrusion and is able to be latched onto the upper housing part 3 by the peripheral edge 112 of the fall-proof washer 11. In this case, the protrusion is made of elastic material.

Therefore, it should be understood by the skilled person in the art that the second structure of the fall-proof washer 11 and the cooperative structure 311 on the receiving seat 31 also are able to be configured in any other suitable manners as long as the second structure is able to be fitted and then latched onto the upper housing part 3. For example, a slot is formed on the receiving seat 31 and a corresponding protrusion is formed on the peripheral edge 112 of the fall-proof washer 11. As another example, the second structure even comprises a slot and a protrusion which each are formed on the peripheral edge 112 of the fall-proof washer 11.

As can be seen from the above, the first structure and the second structure is integrated advantageously as a single fall-proof member, in particular as shown in FIG. 3, thereby simplifying structure and manufacturing of the fall-proof component 1 and facilitating fitting process of the fall-proof component 1.

It should be understood by the skilled person in the art that the fall-proof component 1 also is assembled from a plurality of members.

According to an exemplary embodiment of the present disclosure, the fall-proof member is made at least partially of elastic material, in particular in a region of the second structure, for example in a region of the slot 113, so that the slot 113 is able to be expand easily so as to pass the protrusion formed on the receiving seat 31 to allow for fitting the fall-proof member in place and then is able to be restored at least partially to allow for latching the fall-proof member onto the upper housing part 3. As an example, the elastic material is plastic.

As an example, the fall-proof member is integrally molded, for example by injection molding. In this case, in particular as shown in FIG. 3, the fall-proof member is able to be manufactured easily at a low cost.

Coming back to FIG. 1, the upper housing part 3 is provided with a support structure 32 configured to support the nut 42 to prevent pulling the nut 42 out of the lower housing part 4 during screwing the screw 2 into the nut 42. Specifically, when the screw 2 is screwed, a head 21 of the screw 2 will apply a pressure onto the support structure 32 via the fall-proof washer 11 so as to make the support structure 32 press against an end face of the nut 42, thereby preventing pulling the nut 42 out of the lower housing part 4.

According to an exemplary embodiment of the present disclosure, the support structure 32 is configured as an annular portion, exemplarily an annular flat portion located at a bottom of the receiving seat 31, as shown in FIG. 1.

It can be seen from the above that the fall-proof washer 11 is able to be easily used in various products, in particular electronic products, because of its simple structure. Also, unlike other fall-proof screw which is customized, a standard screw is able to be used according to the disclosure. In particular, the fall-proof washer 11 is disposed adjacent to the head 21 of the screw 2 in the fitted status, which is very advantageous as it allows the upper housing part 3 to provide enough support for the inserted nut 42. Therefore, the nut 42 will not be pulled out of the lower housing part 4 during screwing the screw 2 into the nut 42.

Below described will the fall-proof component 1 configured as a fall-proof cover 12 adapted to be disposed above the head 21 of the screw 2, according to another exemplary embodiment of the present disclosure. For the sake of simplicity, the following description will mainly focus on differences between this embodiment and the embodiment described above.

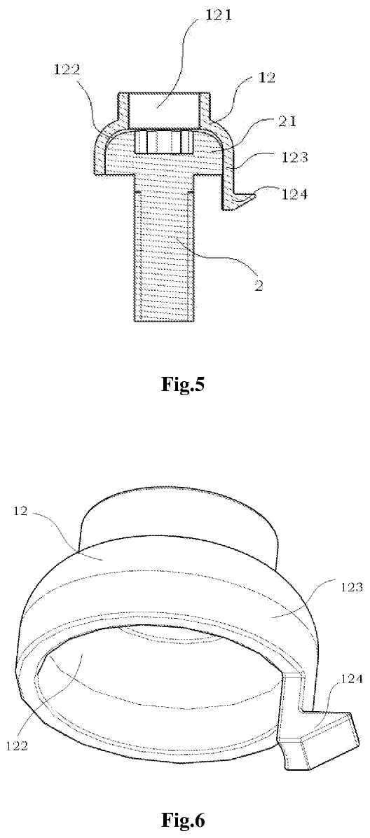

FIG. 4 and FIG. 6 show the fall-proof cover 12 in a similar manner to FIG. 1 and FIG. 3 respectively. FIG. 5 shows in a sectional view a status in which the fall-proof cover 12 is disposed above the head 21 of the screw 2.

According to an exemplary embodiment of the present disclosure, the fall-proof cover 12 comprises a through hole 121 configured to allow for screwing the screw 2 with a tool, for example a screwdriver. That is to say, the through hole 121 is able to expose a portion of the head 21 of the screw 2.

According to an exemplary embodiment of the present disclosure, the fall-proof cover 12 is configured to have a recess 122 adapted to be engaged onto the head 21 of the screw 21. As an example, the recess 122 is configured to have a shape matching with a shape of the head 21 of the screw 2.

In particular, as shown in FIG. 5 and FIG. 6, the fall-proof cover 12 is configured in a bowl shape.

Similarly to the fall-proof washer 11, the second structure of the fall-proof cover 12 comprises a slot and/or a protrusion 124 formed on a peripheral edge 123 of the fall-proof cover 12.

According to an exemplary embodiment of the present disclosure, the slot is configured such that the fall-proof cover 12 is able to be fitted in place by a temporary deformation of the slot and is able to be latched onto the upper housing part 3 by the peripheral edge 123 of the fall-proof cover 12.

As shown in FIG. 4 to FIG. 6, according to an exemplary embodiment of the present disclosure, the protrusion 124 is configured such that the fall-proof cover 12 is able to be fitted in place by a temporary deformation, of exemplarily the protrusion 124, of the fall-proof cover 12 and is able to be latched onto the upper housing part 3 by the protrusion 124.

As an example, as shown in FIG. 4 to FIG. 6, the protrusion 124 is configured as a hook. In this case, as shown in FIG. 4, the cooperative structure 311 on the receiving seat 31 is correspondingly configured as a groove into which the hook is able to be engaged.

It can be seen from the above that due to elastic deformation, the fall-proof washer 11 and the fall-proof cover 12 is detached from the upper housing part 3 for example by means of a suitable tool.

As an example, the cooperative structure 311 is configured such that the fall-proof component 1 still is latched onto the upper housing part 3 even if the screw 2 is unscrewed from the nut 42.

Further, the fall-proof component 1, for example the fall-proof washer 11 and the fall-proof cover 12 is reusable even after the fall-proof component 1 is detached from the upper housing part 3.

The present disclosure also proposes a fall-proof screw assembly comprising the fall-proof component 1 and the screw 2, and a fall-proof screw-nut assembly comprising the fall-proof screw assembly and the nut 42 for the screw 2.

In addition, the present disclosure further proposes a part, for example the upper housing part 3, suitable for the fall-proof screw assembly, wherein the part is provided with the receiving seat 31 for receiving the fall-proof screw assembly, which receiving seat 31 is provided with the cooperative structure 311 for cooperating with the second structure to prevent the screw 2 from falling.

Further, the present disclosure proposes a combination structure comprising the part described above as a first part, for example the upper housing part 3, and a second part, for example the lower housing part 4, provided with the nut 42, wherein the first part and the second part are configured to be fixed with each other at least by engaging of the screw 2 in the fall-proof screw assembly with the nut 42.

Also, the present disclosure proposes an assembly comprising the combination structure described above and the fall-proof screw assembly described above.

While certain embodiments have been described, these embodiments have been presented by way of example only, and are not intended to limit the scope of the disclosure. The attached claims and their equivalents are intended to cover all the modifications, substitutions and changes as would fall within the scope and spirit of the disclosure.

1-20. (canceled)

21. A fall-proof component for a screw, comprising:
a first structure configured to act on a portion of the screw to stop the screw; and
a second structure configured to be fitted and latched onto a part which is to be fixed by the screw;
wherein the first structure and the second structure cooperate with each other to prevent the screw from falling and the fall-proof component is configured to be adapted to be disposed adjacent to a head of the screw in a fitted status.

22. The fall-proof component according to claim 21, wherein
the first structure and the second structure are integrated as a single fall-proof member; and/or
the fall-proof component is configured to be reusable; and/or
the fall-proof component is configured to be detachable from the part.

23. The fall-proof component according to claim 22, wherein
the fall-proof member is at least partially made of elastic material; and/or
the fall-proof member is integrally molded.

24. The fall-proof component according to claim 23, wherein
the elastic material is plastic; and/or
the fall-proof member is molded by injection molding.

25. The fall-proof component according to claim 21, wherein
the fall-proof component is configured as a fall-proof washer.

26. The fall-proof component according to claim 25, wherein
the fall-proof washer comprises a through hole acting as the first structure; and/or
the second structure is disposed at a peripheral edge of the fall-proof washer.

27. The fall-proof component according to claim 26, wherein
the through hole is configured to hold the fall-proof washer on the screw; and/or
the second structure comprises a slot and/or a protrusion formed on the peripheral edge of the fall-proof washer.

28. The fall-proof component according to claim 27, wherein
the fall-proof washer is held on the screw by self-tapping the screw into the through hole; and/or
the slot is configured such that the fall-proof washer is able to be fitted in place by a temporary deformation of the slot and is able to be latched onto the part by the peripheral edge of the fall-proof washer; and/or
the protrusion is configured such that the fall-proof washer is able to be fitted in place by a temporary deformation, of exemplarily the protrusion, of the fall-proof washer and is able to be latched onto the part by the protrusion.

29. The fall-proof component according to claim 21, wherein
the fall-proof component is configured as a fall-proof cover adapted to be disposed above the head of the screw.

30. The fall-proof component according to claim 29, wherein
the fall-proof cover comprises a through hole configured to allow for screwing the screw with a tool; and/or
the fall-proof cover is configured to have a recess adapted to be engaged onto the head of the screw.

31. The fall-proof component according to claim 30, wherein
the fall-proof cover is configured in a bowl shape; and/or
the second structure comprises a slot and/or a protrusion formed on a peripheral edge of the fall-proof cover.

32. The fall-proof component according to claim 31, wherein
the slot is configured such that the fall-proof cover is able to be fitted in place by a temporary deformation of the slot and is able to be latched onto the part by the peripheral edge of the fall-proof cover; and/or
the protrusion is configured such that the fall-proof cover is able to be fitted in place by a temporary deformation, of exemplarily the protrusion, of the fall-proof cover and is able to be latched onto the part by the protrusion.

33. The fall-proof component according to claim 31, wherein
the protrusion is configured as a hook.

34. The fall-proof component according to claim 22, wherein
the fall-proof component is configured as a fall-proof washer.

35. The fall-proof component according to claim 22, wherein
the fall-proof component is configured as a fall-proof cover adapted to be disposed above the head of the screw.

36. A fall-proof screw assembly comprising:
a screw; and
a fall-proof component for the screw, the fall-proof component comprising:
a first structure configured to act on a portion of the screw to stop the screw; and
a second structure configured to be fitted and latched onto a part which is to be fixed by the screw;
wherein the first structure and the second structure cooperate with each other to prevent the screw from falling and the fall-proof component is configured to be adapted to be disposed adjacent to a head of the screw in a fitted status.

37. A part suitable for a fall-proof screw assembly, wherein the part is provided with a receiving seat for receiving the fall-proof screw assembly, the fall-proof screw assembly comprising:
a screw; and
a fall-proof component for the screw, the fall-proof component comprising:
a first structure configured to act on a portion of the screw to stop the screw; and
a second structure configured to be fitted and latched onto a part which is to be fixed by the screw;
wherein the first structure and the second structure cooperate with each other to prevent the screw from falling and the fall-proof component is configured to be adapted to be disposed adjacent to a head of the screw in a fitted status.
wherein the receiving seat is provided with a cooperative structure for cooperating with the second structure to prevent the screw from falling.

38. The part according to claim 37, wherein the cooperative structure is configured such that the fall-proof component still is able to be latched onto the part even if the screw is unscrewed from the nut.

39. A combination structure comprising:
a part suitable for a fall-proof screw assembly, wherein the part is provided with a receiving seat for receiving the fall-proof screw assembly, the fall-proof screw assembly comprising:
a screw; and
a fall-proof component for the screw, the fall-proof component comprising:
a first structure configured to act on a portion of the screw to stop the screw; and
a second structure configured to be fitted and latched onto a part which is to be fixed by the screw;
wherein the first structure and the second structure cooperate with each other to prevent the screw from falling and the fall-proof component is configured to be adapted to be disposed adjacent to a head of the screw in a fitted status,
wherein the receiving seat is provided with a cooperative structure for cooperating with the second structure to prevent the screw from falling,
wherein the part is provided as a first part and a second part provided with a nut, and
wherein the first part and the second part are configured to be fixed with each other at least by engaging of the screw in the fall-proof screw assembly with the nut.

40. The combination structure according to claim 39, wherein:
the nut is inserted in the second part during injection molding of the second part; and/or
the first part is provided with a support structure configured to support the nut to prevent pulling the nut out of the second part during screwing the screw into the nut; and/or
the combination structure is configured as a housing for a touch screen monitor.
